(19) United States
(12) Patent Application Publication
(10) Pub. No.: US 2011/0026595 A1
(43) Pub. Date: Feb. 3, 2011

(54) VIDEO ENCODING/DECODING APPARATUS

(75) Inventors: Goki Yasuda, Kawasaki-shi (JP); Takeshi Chujoh, Kawasaki-shi (JP)

Correspondence Address: Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/869,838

(22) Filed: Aug. 27, 2010

Related U.S. Application Data
(63) Continuation of application No. PCT/JP2009/053684, filed on Feb. 27, 2009.

(30) Foreign Application Priority Data
Feb. 27, 2008 (JP) 2008-046180

(51) Int. Cl. H04N 7/26

(52) U.S. Cl. 375/240.13; 375/E07.243

(57) ABSTRACT

According to one embodiment, an image encoding apparatus performs encoding according to coefficient information whose probability distribution differs due to a prediction method. The image encoding apparatus includes a plurality of probability estimators provided for a plurality of prediction directions of intra-picture prediction and configured to estimate occurrence probabilities of coefficient information respectively, a switch to select a probability estimator according to information of a prediction direction used for intra-picture prediction, and a variable length encoder to encode coefficient information according to occurrence probability of coefficient information provided from a probability estimator selected by the switch.

### CROSS REFERENCE TO RELATED APPLICATIONS

This is a Continuation Application of PCT Application No. PCT/JP2009/053684, filed Feb. 27, 2009, which was published under PCT Article 21(2) in Japanese.

This application is based upon and claims the benefit of priority from Japanese Patent Application No. 2008-046180, filed on Feb. 27, 2008; the entire contents of which are incorporated herein by reference.

### BACKGROUND

1. Field

This disclosure relates to an image encoding/decoding apparatus for generating a prediction image of a to-be-encoded image and encoding/decoding information of coefficients obtained by transforming and quantizing a prediction error.

2. Description of the Related Art

In general, Context-based Adaptive Binary Arithmetic Coding (CABAC) and Context-based Adaptive Variable-length coding (CAVLC) are used for encoding information. In CABAC process, a probability estimator estimates occurrence probability of information to be encoded and the information is entropy-encoded using the estimated occurrence probability. In CAVLC process, a code table is selected according to the adjacent block that has been encoded and entropy encoding is performed according to the selected code table.

### BRIEF DESCRIPTION OF THE DRAWINGS

Aspects of this disclosure will become apparent upon reading the following detailed description and upon reference to the accompanying drawings.

The description and the associated drawings are provided to illustrate embodiments of the invention and not limited to the scope of the invention.

FIG. 1 is a block diagram of an image encoding apparatus relating to a first embodiment.

FIG. 2 is a flowchart for explaining an image encoding method using the image encoding apparatus of FIG. 1.

FIG. 3 is a block diagram of an entropy encoder relating to the first embodiment.

FIG. 4 is a flowchart for explaining an encoding method using the entropy encoder of FIG. 3.

FIG. 5 is a diagram illustrating directional prediction.

FIG. 6 is a diagram illustrating a corresponding state between a prediction mode and a pixel block.

FIG. 7 is a block diagram of an entropy encoder relating to the second embodiment.

FIG. 8 is a flowchart for explaining an encoding method using the entropy encoder of FIG. 7.

FIG. 9 is a block diagram of an image decoding apparatus relating to a third embodiment.

FIG. 10 is a flowchart for explaining an image decoding method using the image decoding apparatus of FIG. 9.

FIG. 11 is a block diagram of an entropy decoder relating to the third embodiment.

FIG. 12 is a flowchart for explaining a decoding method using the entropy decoder of FIG. 11.

FIG. 13 is a block diagram of an entropy decoder relating to a fourth embodiment.

FIG. 14 is a flowchart for explaining a decoding method using the entropy decoder of FIG. 13.

### DETAILED DESCRIPTION

According to an example embodiment, an image encoding apparatus encodes coefficient information representing a coefficient obtained by orthogonal-transforming a prediction error between a to-be-encoded image and a prediction image and quantizing an orthogonal-transformed prediction error. The image encoding apparatus comprises a plurality of probability estimators provided for a plurality of prediction directions of intra-picture prediction and configured to estimate occurrence probabilities of coefficient information, respectively, a switch to select a probability estimator from the probability estimators according to information of a prediction direction used for the intra-picture prediction, and a variable length encoder to encode the coefficient information according to occurrence probability of coefficient information provided from the probability estimator selected with the switch.

There will now be described an embodiment referring to drawings.

### The First Embodiment

### An Encoding Apparatus

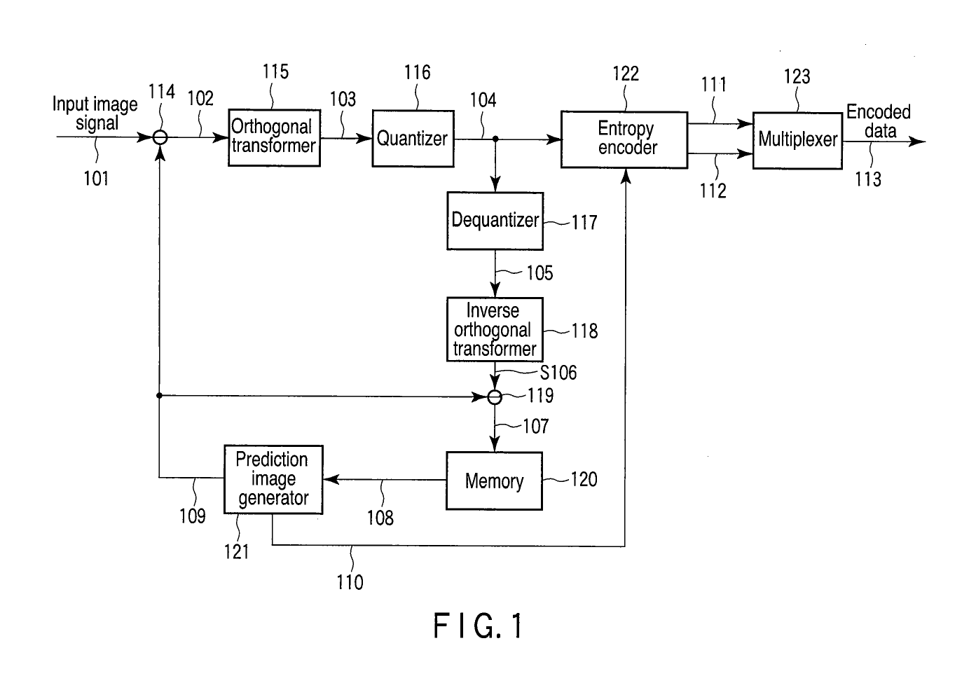

There will be described an image encoding apparatus relating to the first embodiment referring to FIG. 1. A subtracter 114 receives an input image signal 101 and a prediction image signal 109 and produces a prediction error signal 102. The output terminal of the subtracter 114 is connected to the input terminal of an orthogonal transformer 115. The orthogonal transformer 115 subjects the prediction error signal 102 to orthogonal transform and outputs a transform coefficient 103. The output terminal of the orthogonal transformer 115 is connected to the input terminal of a quantizer 116. The quantizer 116 quantizes the transform coefficient 103. The output terminal of the quantizer 116 is connected to the input terminal of an entropy encoder 122 and the input terminal of a dequantizer 117. The entropy encoder 122 entropy-encodes a quantized transform coefficient 104. The dequantizer 117 dequantizes the quantized transform coefficient 104.

The output terminal of the dequantizer 117 is connected to the input terminal of an inverse orthogonal transformer 118. The inverse orthogonal transformer 118 subjects a dequantized transform coefficient 105 output from the dequantizer 117 to inverse orthogonal transform. The output terminal of the inverse orthogonal transformer 118 is connected to an adder 119. The adder 119 adds the inverse-orthogonal-transformed signal and the prediction signal and produces a local decoded picture signal 107. In other words, the dequantizer 117, the inverse orthogonal transformer 118 and the adder 119 configures a local decoded signal generator. The output terminal of the adder 119 is connected to a memory 120. The output terminal of the memory 120 is connected to the input terminal of the prediction image generator 121. The prediction image generator 121 generates a prediction image signal 109 and prediction information 110. The prediction image signal output terminal and prediction information output terminal of the prediction image generator 121 are connected to inputs of the subtracter 114 and entropy encoder 122, respectively.

The coefficient information encoded data output terminal and prediction information encoded data output terminal of the entropy encoder 122 are connected to the input terminal of a multiplexer 123.

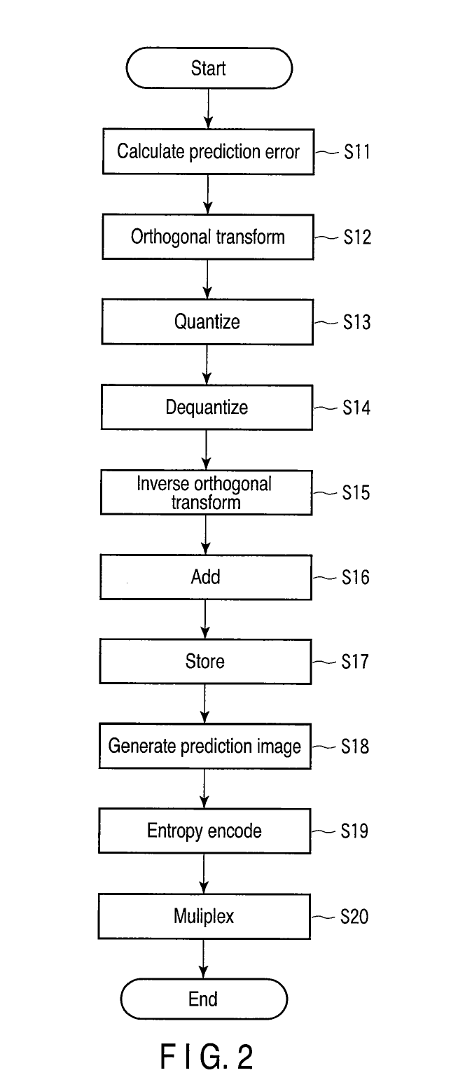

The image encoding method using the image encoding apparatus of the above configuration will be described referring to the flowchart of FIG. 2. The input image signal 101 of a to-be-encoded image is input to the subtracter 114. The subtracter 114 calculates a difference between the input image signal 101 and the prediction image signal 109 and produces a prediction error signal 102 (S11). The orthogonal transformer 115 orthogonal-transforms the prediction error signal 102 and generates an orthogonal transform coefficient 103 (S12). The quantizer 116 quantizes the orthogonal transformed coefficient 103 (S13). As a result, the quantizer 116 outputs information of the coefficient obtained by subjecting the prediction error signal 102 to orthogonal transform and quantization. The coefficient information 104 is dequantized with the dequantizer 117, and then is subjected to inverse orthogonal transform with the inverse orthogonal transformer 118 so that a prediction error signal 106 corresponding to the prediction error signal 102 is reproduced (S14, S15). The adder 119 adds the prediction error signal 106 and the prediction image signal 109 from the prediction image generator 121 and produces a local decoded image signal 107 (S16). The local decoded image signal 107 is stored in the memory 120 (S17). The local decoded image signal 108 read from the memory 120 is input to the prediction image generator 121. The prediction image generator 121 produces a prediction image signal 109 from the local decoded picture signal 108 stored in the memory 120 (S18).

The prediction information 110 produced with the prediction image generator 121 is sent to the entropy encoder 122. The entropy encoder 122 subjects the coefficient information 104 and the prediction information 110 to variable-length coding and produces encoded data corresponding to the coefficient information 104 and the prediction information 110, respectively (S19). The encoded data 111 of the coefficient information and encoded data 112 of the prediction information are input to the multiplexer 123. The multiplexer 123 multiplexes the encoded data 111 of the coefficient information and the encoded data 112 of the prediction information and produces multiplexed encoded data 113 (S20).

The prediction image generator 121 will now be explained.

The prediction image generator 121 produces the prediction image signal 109 from the local decoded image signal 108 based on intra-picture prediction. Further, the prediction image generator 121 obtains a prediction direction of the intra-picture prediction and produces information concerning a prediction method, i.e., prediction information 110. This prediction information 110 is sent to the entropy encoder 122. The intra-picture prediction uses Intra Prediction of H.264, for example, (referring to 8.3 sections of Text of ISO/IEC 14496-10: 2004 Advanced Video Coding (second edition)).

About the block which Intra_{—}4×4 Prediction is applied to, a prediction mode is selected from nine prediction modes, then the selected prediction mode is used for prediction and sent to the entropy encoder 122 as the prediction information 110. The similar procedure is performed also about the block which Intra Prediction except Intra_{—}4×4 is applied to.

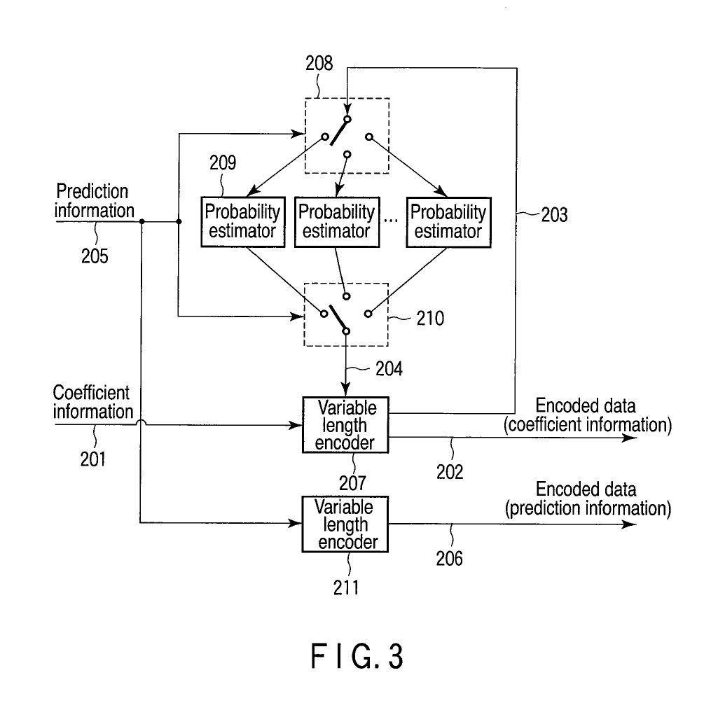

The entropy encoder 122 will now be explained referring to FIG. 3.

The entropy encoder 122 comprises a switch 208, a switch 210 and a variable-length coding device 211, which receive prediction information 205 corresponding to the prediction information 110 of FIG. 1. The switch 208 is connected to a plurality of probability estimators 209 for estimating occurrence probability of coefficient information 203 described below. These probability estimators 209 each estimates occurrence probability of coefficient information according to a plurality of prediction directions of intra-picture prediction. The output terminals of the probability estimators 209 are connected to the variable length encoder 207 through the switch 210.

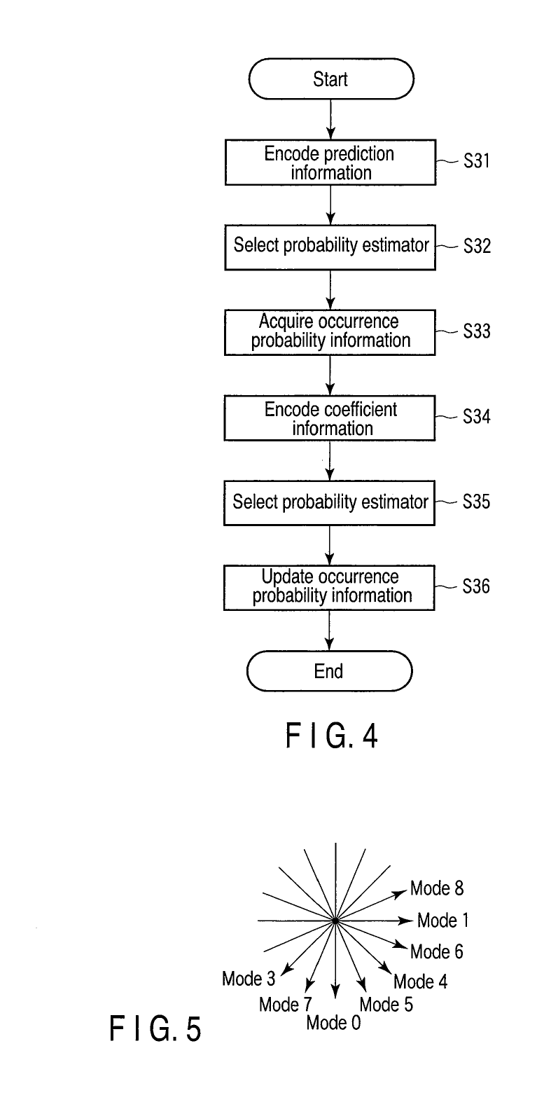

An entropy coding method using the entropy encoder 122 of the above configuration will be described referring to the flowchart of FIG. 4. The prediction information 205 corresponding to the prediction information 110 of FIG. 1 is input to the switch 208, the switch 210 and the variable length encoder 211. The coefficient information 201 corresponding to the coefficient information 104 of FIG. 1 is input to the variable length encoder 207. The variable length encoder 211 subjects the prediction information 205 to variable-length encoding and outputs encoded data 206 of the prediction information (S31). The switch 210 selects the probability estimator 209 according to the prediction information 205 (S32), and sends occurrence probability information 204 retained in the selected probability estimator to the variable length encoder 207. The variable length encoder 207 acquires occurrence probability information 204 through the switch 210 (S33), subjects the input coefficient information 201 to variable-length encoding according to the occurrence probability information 204 (S34), outputs the encoded data 202 of the coefficient information 201 and outputs encoded coefficient information 203 to the switch 208. The switch 208 selects the probability estimator 209 according to the prediction information 205 (S35), and sends the encoded coefficient information 203 to the selected probability estimator. The probability estimator selected with the switch 208 acquires the encoded coefficient information 203 through the switch 208, and updates occurrence probability information (S36).

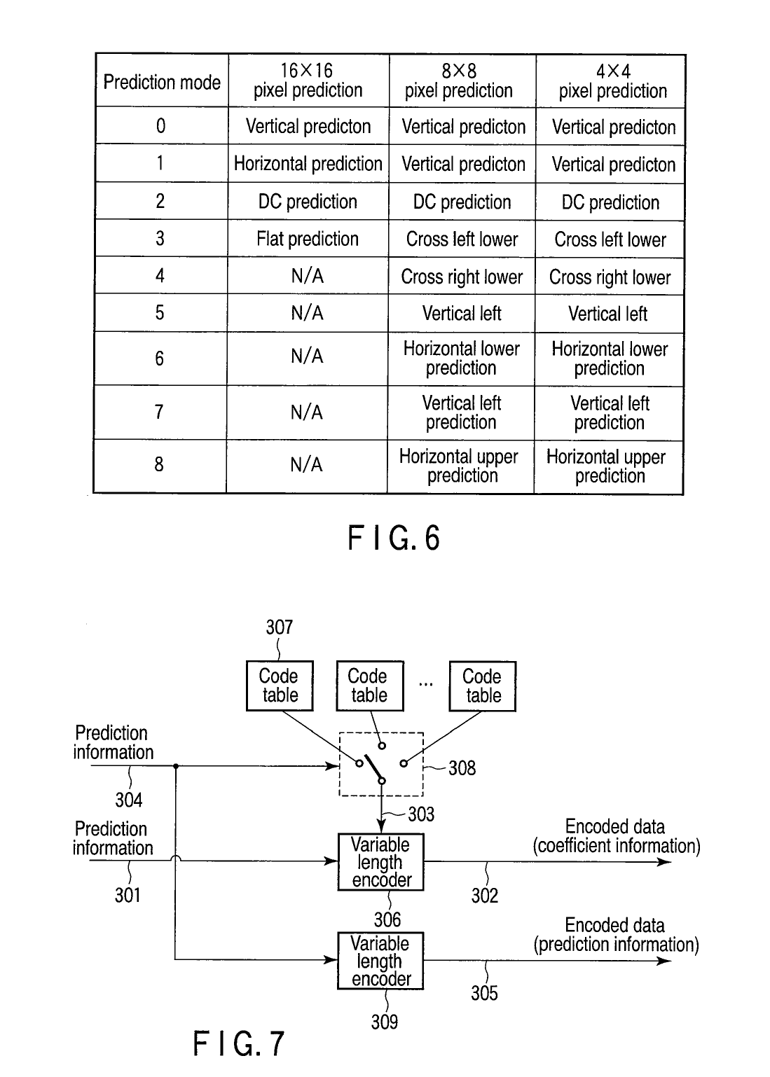

The probability estimator 209 estimates occurrence probability of the orthogonal transformed/quantized coefficient of the coefficient information for each prediction direction. Therefore, the probability estimator 209 is provided for each prediction direction (each prediction mode 0-8) of intra-picture prediction as shown in FIGS. 5 and 6. In FIG. 6, prediction directions for 16×16 pixel block, 8×8 pixel block and 4×4 pixel block are shown. “N/A” shows that a corresponding prediction method is not defined. The present embodiment is explained as an example of obtaining a prediction error of a prediction image for each prediction direction and generating a prediction image of the prediction direction that a prediction error is most decreased.

There is explained an example wherein the prediction image is generated by Intra_{—}4×4 Prediction of H.264, a coefficient of a prediction error is encoded by a data structure according to Residual Block CABAC Syntax of H.264, and a syntax element significant_coeff_flag of the i-th coefficient position in a 4×4 block is encoded as coefficient information. The image encoding apparatus possesses nine probability estimators 209 corresponding to nine prediction modes of Intra_{—}4×4 Prediction, respectively. The switch 208 selects the probability estimator 209 corresponding to an input prediction mode, and sends a value of the encoded syntax element significant_coeff_flag to the selected probability estimator 209. Each probability estimator 209 has a configuration similar to the probability estimator of CABAC.

The value of pStateIdx, valMPS of the probability estimator 209 selected with the switch 208 is updated using the value of the input syntax element significant_coeff_flag. The probability estimator 209 selected with the switch 208 sends the value of pStateIdx, valMPS to the switch 210. The switch 210 selects the probability estimator 209 corresponding to the input prediction mode, and sends the value of pStateIdx, valMPS provided from the selected probability estimator 209 to the variable length encoder 207. The variable length encoder 207 subjects the syntax element significant_coeff_flag to variable-length encoding according to the value of pStateIdx, valMPS provided from the switch 210 by processing similar to CABAC, and outputs the encoded data 202 of coefficient information. The value of syntax element significant_coeff_flag is sent to the switch 208 from the variable length encoder 207. The variable length encoder 211 subjects the input prediction mode 205 to variable-length encoding, and output the encoded data 206 of the prediction mode. The variable length encoder 211 subjects information of the prediction mode 205 to variable-length encoding by a method similar to H.264.

The image encoding apparatus of the present embodiment possesses the probability estimator one by one for each prediction direction of intra-picture prediction, but the probability estimator may be provided by one for each group which a prediction direction of intra-picture prediction sorted beforehand belongs to. For example, in an example of encoding the syntax element significant_coeff_flag, nine prediction modes are sorted into three groups of group A of prediction modes 0,5,7, a group B of prediction modes 1,6,8 and a group C of prediction modes 2,3,4. One probability estimator may be provided for each group, that is, a total of three probability estimators may be provided.

### The Second Embodiment

### An Encoding Apparatus

There will be explained an image encoding apparatus relating to the second embodiment. The basic configuration of the image encoding apparatus relating to the present embodiment is similar to the base configuration of the image encoding apparatus relating to the first embodiment shown in FIG. 1.

The entropy encoder of the present embodiment is described with reference to FIG. 7. The entropy encoder of the present embodiment comprises a plurality of code tables 307. The code tables 307 are connected to the variable length encoder 306 through the switch 308. The variable length encoder 306 subjects the coefficient information 301 to variable-length encoding using the code table 307. The switch 308 switches the code table 307 to be connected to the variable length encoder 306 according to the prediction information 304. The variable length encoder 309 encodes the prediction information 304.

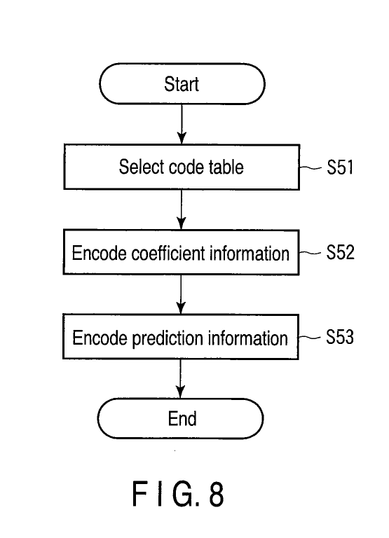

Encoding process using the entropy encoder of the above configuration will be described referring to FIG. 8. When the prediction information 304 is input to the switch 308 and the variable length encoder 309, the switch 308 selects the code table 307 according to the prediction mode designated by the prediction information 304 (S51), and sends information 303 of the selected code table 307 to the variable length encoder 306. The variable length encoder 306 subjects input coefficient information 301 to variable-length encoding according to the information 303 of the selected code table 307 (S52), and outputs encoded data 302 of coefficient information.

The code table 307 is provided one by one for each prediction direction of the intra-picture prediction. The variable length encoder 309 subjects the input prediction information 304 to variable-length encoding (S53), and outputs encoded data 305 of the prediction information.

There will be described an example wherein the prediction image is generated by Intra_{—}4×4 Prediction of H.264, the coefficient of the prediction error is encoded by data structure according to Residual Block CAVLC Syntax of H.264, and run_before is encoded as coefficient information. The image encoding apparatus has nine code tables 307 corresponding to nine prediction modes of Intra_{—}4×4 Prediction, respectively. About each code table, a code table indicating a corresponding relation between a set of values of run_before, zerosLeft and a code word is used in common with a decoding apparatus similarly to H.264. The switch 308 selects a code table to corresponding to the prediction mode of the input prediction information 304 and sends information 303 of the code table to the variable length encoder 306.

The variable length encoder 306 subjects the coefficient information 301 to variable-length encoding according to the information 303 of the code table provided from the switch 308, and outputs encoded data 302 of the coefficient information. The variable length encoder 309 subjects the input prediction mode 304 to variable-length encoding and outputs encoded data 305 of the prediction mode. The variable length encoder 309 subjects the information of prediction mode 304 to variable-length encoding by a method similar to H.264.

The image encoding apparatus of the present embodiment possesses a code table one by one for each prediction direction of intra-picture prediction, but a code table may be provided for each group which a prediction direction of intra-picture prediction sorted beforehand belongs to. For example, in an example of encoding the run_before, nine prediction modes are sorted into three groups of a group A of prediction modes 0,5,7, a group B of prediction modes 1,6,8 and a group C of prediction modes 2,3,4. One probability estimator may be provided for each group, that is, a total of three probability estimators may be provided.

### A Third Embodiment

### A Decoding Apparatus

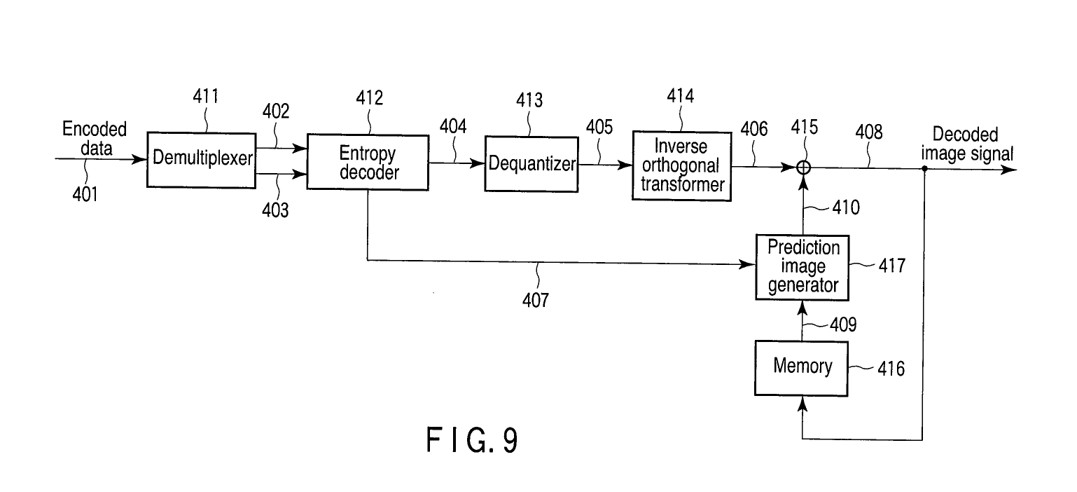

An image decoding apparatus relating to the third embodiment is described with reference to FIG. 9.

An image decode apparatus comprises a demultiplexer 411 to demultiplex multiplexed encoded data 401 into encoded data 402 of coefficient information and encoded data 403 of prediction information and an entropy decoder 412 to entropy-decode the encoded data 402 of the coefficient information and the encoded data 403 of the prediction information. The output terminal of the entropy decoder 412 is connected to a dequantizer 413 and a prediction image generator 417. The output terminal of the dequantizer 413 is connected to one input terminal of an adder 415 through an inverse orthogonal transformer 414. The output terminal of the adder 415 is connected to a prediction image generator 417 through a memory 416. The output terminal of the prediction image generator 417 is connected to the other input terminal of the adder 415.

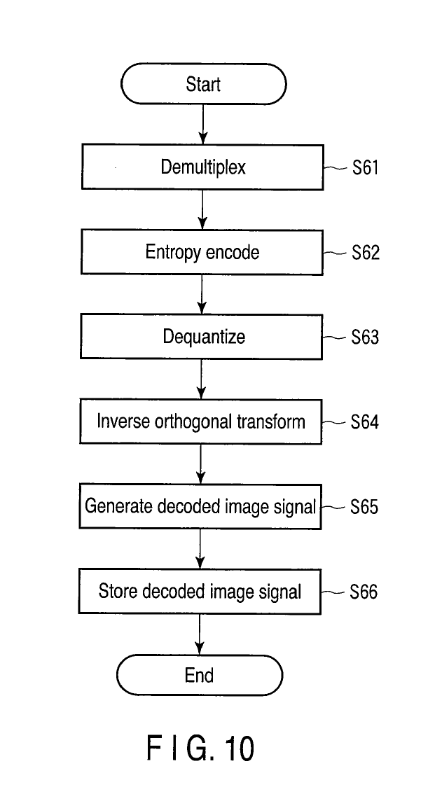

An image decoding method using the image decoding apparatus of the above configuration will be described referring to the flowchart of FIG. 10. When the encoded data 401 is input to the demultiplexer 411, the encoded data 401 is demultiplexed to the encoded data 402 of the coefficient information and the encoded data 403 of the prediction information. The encoded data 402 of the coefficient information and the encoded data 403 of the prediction information are input to the entropy decoder 412. The entropy decoder 412 entropy-decodes (variable-length decodes) the encoded data 402 of the coefficient information and the encoded data 403 of the prediction information (S62), and generates coefficient information 404 and prediction information 407.

The coefficient information 404 is input to the dequantizer 413, and the prediction information 407 is input to the prediction image generator 417. The coefficient information 404 is dequantized with the dequantizer 413 (S63), and then is subjected to inverse orthogonal transform with the inverse orthogonal transform 414 (S64). As a result, a prediction error signal 406 is provided. The adder 415 adds the prediction error signal 406 and the prediction image signal 410 to reproduce a decoded image signal 408 (S65). The reproduced decoded image signal 408 is stored in the memory 416 (S66). The prediction image generator 417 generates a prediction image signal 410 from a decoded image signal 409 stored in the memory, using a prediction method designated by the prediction information 407.

There will now be described the prediction image generator 417.

The prediction image generator 417 generates the prediction image signal 410 by intra-picture prediction designated by the prediction information 407. The intra-picture prediction common to the prediction image generator of the encoding apparatus is used. For example, Intra Prediction of H.264 is used.

About the block which Intra_{—}4×4 Prediction is applied to, one of nine prediction modes that is to be used for prediction is specified by the prediction information 407, and the prediction is done by the specified prediction mode to produce the prediction image signal 410.

About the block which Intra Prediction except Intra_{—}4×4 is applied to, the similar procedure may be done.

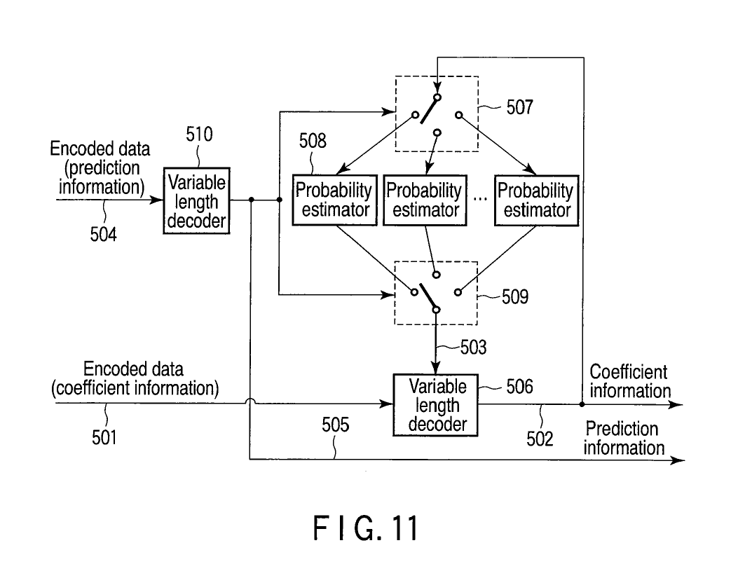

An entropy decoder will now be explained referring to FIG. 11.

An entropy decoder comprises a variable length decoder 510. The variable length decoder 510 subjects the encoded data 504 of the prediction information to variable-length encoding. The output terminal of the variable length decoder 510 is connected to switches 507 and 509. A plurality of probability estimators 508 are connected between the switches 507 and 509. The output terminal of the switch 509 is connected to the variable length decoder 506. The variable length decoder 506 subjects the encoded data 501 of the coefficient information to variable-length decoding. The output terminal of the variable length decoder 506 is connected to the input terminal of the switch 507.

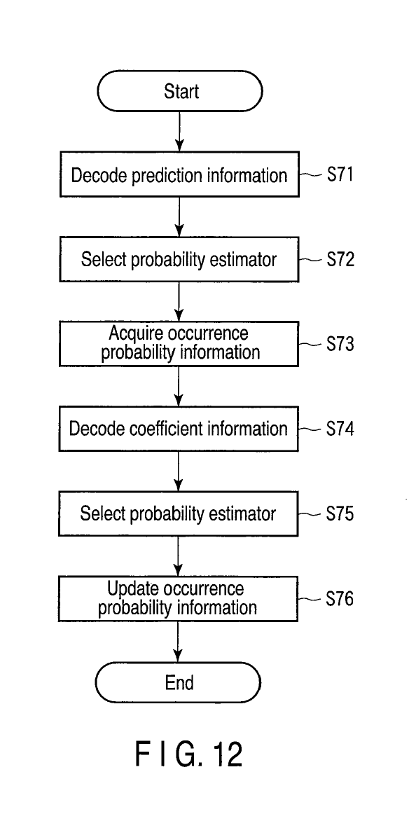

An entropy decoding process using the above entropy decoder will be described referring to the flowchart of FIG. 12. When the encoded data 504 of the prediction information is input to the variable length decoder 510, the variable length decoder 510 subjects the encoded data 504 of the prediction information to variable-length decoding (S71), and outputs decode prediction information 505. The decoded prediction information 505 also is output to the switches 507 and 509. The switch 509 selects the probability estimator 508 according to the decoded prediction information 505 (S72), and sends occurrence probability information 503 retained in the selected probability estimator to the variable decoder 506. The variable length decoder 506 acquires the occurrence probability information 503 through the switch 509 (S73), subjects the encoded data 501 of the input coefficient information to variable-length decoding according to the occurrence probability information 503 (S74), and outputs coefficient information 502. The decoded coefficient information 502 is sent to the switch 507 from the variable length decoder 506. The switch 507 selects the probability estimator 508 according to the decoded prediction information 505 (S75), and sends the decoded coefficient information 502 to the selected probability estimator. The probability estimator selected with the switch 507 acquires the decoded coefficient information 502 through the switch 507, and updates the occurrence probability information (S76).

There will be described an example wherein a prediction image is generated by Intra_{—}4×4 Prediction of H.264, the coefficient of the prediction error is encoded by the data structure according to Residual Block CABAC Syntax of H.264, and the syntax element significant_coeff_flag of the i-th coefficient position in a 4×4 block is decoded as coefficient information. The image decoding apparatus of the present embodiment possesses nine probability estimators corresponding to nine prediction modes of Intra_{—}4×4 Prediction, respectively. The switch 507 selects the probability estimator 508 corresponding to an input prediction mode. The value of the decoded syntax element significant_coeff_flag is sent to the selected probability estimator 508. The probability estimator 508 has a configuration similar to the probability estimator of CABAC. The value of pStateIdx, valMPS of the probability estimator 508 selected with the switch 507 is updated using the value of the input syntax element significant_coeff_flag. The probability estimator 508 selected with the switch 509 sends the value of pStateIdx, valMPS to the switch 509. The switch 509 selects the probability estimator corresponding to the input prediction mode, and sends the value of pStateIdx, valMPS provided from the selected probability estimator 508 to the variable length decoder 506. The variable length decoder 506 subjects the encoded data of syntax element significant_coeff_flag to variable-length decoding according to the value of pStateIdx, valMPS provided from the switch 509 by processing similar to CABAC, and outputs the value of the syntax element significant_coeff_flag. The value of the syntax element significant_coeff_flag is sent to the switch 507 from the variable length decoder 506. The variable length decoder 510 subjects the encoded data 504 of the input prediction mode to variable-length decoding, and outputs a prediction mode. The variable length decoder 510 subjects the information of the prediction mode to variable-length decoding by a method similar to H.264.

The image decoding apparatus of the present embodiment possesses the probability estimator one by one for each prediction direction of the intra-picture prediction, but one probability estimator may be provided for each group which prediction directions of intra-picture prediction sorted beforehand belongs to. For example, in an example of decoding the syntax element significant_coeff_flag, nine prediction modes are sorted into three groups of a group A of prediction modes 0,5,7, a group B of prediction modes 1,6,8 and a group C of prediction modes 2,3,4. One probability estimator may be provided for each group, that is, a total of three probability estimators may be provided.

### The Fourth Embodiment

### A Decoding Apparatus

There will be explained an image decoding apparatus relating to the fourth embodiment. The basic configuration of the image decoding apparatus relating to the present embodiment is similar to the base configuration of the image decode apparatus relating to the third embodiment shown in FIG. 9.

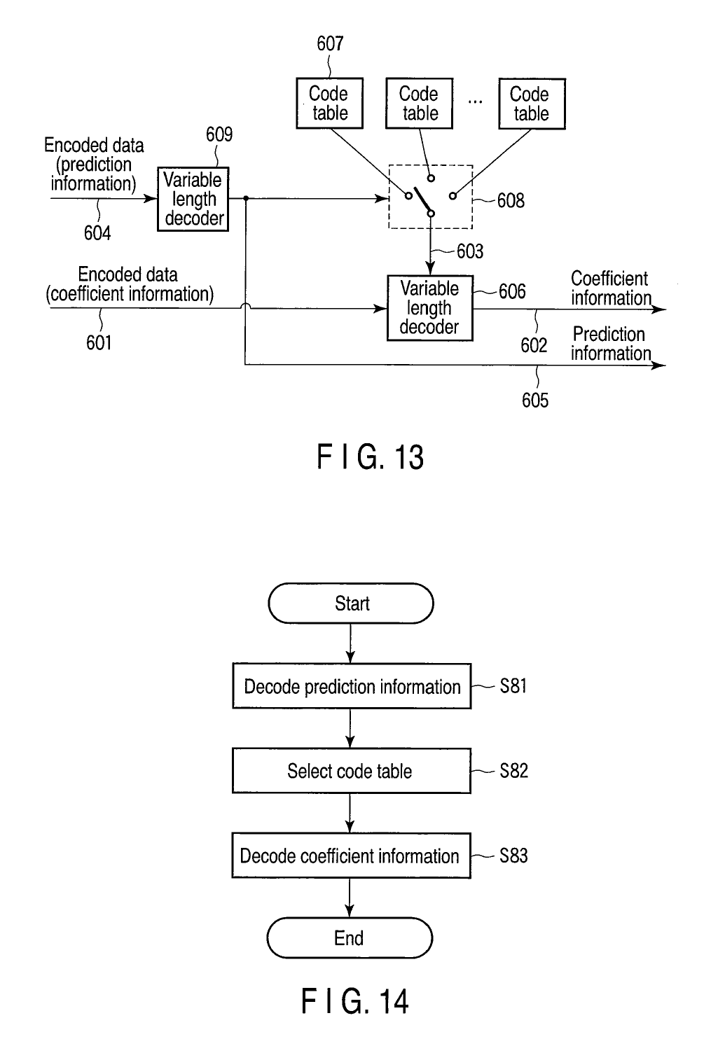

An entropy decoder is explained referring to FIG. 13.

The entropy decoder of the present embodiment comprises a variable length decoder 609 to subject encoded data of prediction information to variable-length decoding. The output terminal of the variable length decoder 609 is connected to the switch 608. The switch 608 is connected between a plurality of code tables 607 and a variable length decoder 606, and selects the code table 607 according to a prediction mode of decoded prediction information.

The entropy decoding method using the entropy decoder described above will be described referring to the flowchart of FIG. 14. When the encoded data 604 is input to the variable length decoder 609, the variable length decoder 609 subjects the encoded data 609 of input prediction information to variable-length decoding (S81), outputs decoded prediction information 605, and inputs it to the switch 608. The switch 608 selects the code table 607 according to the prediction mode of the decoded prediction information 605 (S82), and sends the code table information 603 of the selected code table 607 to the variable length decoder 606. The variable length decoder 606 decodes the coefficient information of input encoded data 601 according to the code table information 603, and outputs coefficient information 602 (S83). It is assumed that the code table is provided one by one for each prediction direction of the intra-picture prediction.

There will be explained an example wherein a prediction image is generated by Intra_{—}4×4 Prediction of H.264, a coefficient is assumed to be a configuration similar to Residual Block CAVLC Syntax of H.264, and run_before is decoded as coefficient information. The image decoding apparatus possesses nine code tables corresponding to nine prediction modes of Intra_{—}4×4 Prediction, respectively. About each code table, the code table indicating a corresponding relation between a set of values of run_before, zerosLeft and a code word is used in common with the encoding apparatus similarly to H.264. The switch 608 selects a code table corresponding to the input prediction mode, and sends information 603 of the code table to the variable length decoder 606. The variable length decoder 606 performs variable-length decoding according to the information 603 of the code table provided from the switch 608, and outputs the value of run_before. The variable length decoder 609 subjects the encoded data 604 of input prediction mode to variable-length decoding, and outputs a prediction mode 605. The variable-length decoding of the prediction mode with the variable length decoder 609 may be done similarly to H.264.

In the present embodiment, a code table is provided for each prediction direction of the intra-picture prediction, but one code table may be provided for each group which prediction directions of the intra-picture prediction sorted beforehand belongs to. For example, in an example of encoding the run_before, nine prediction modes are sorted into three groups of a group A of prediction modes 0,5,7, a group B of prediction modes 1,6,8 and a group C of prediction modes 2,3,4. One probability estimator may be provided for each group, that is, a total of three probability estimators may be provided.

As described above, according to the present embodiments, occurrence probabilities of coefficient information for a plurality of prediction directions of intra-picture prediction or grouped prediction directions obtained by sorting a plurality of prediction directions are estimated respectively, the estimated occurrence probability of coefficient information is selected from estimated occurrence probabilities according to prediction information used for the intra-picture prediction, and the coefficient information is subjected to variable-length encoding according to the selected occurrence probability.

Further, a plurality of code tables are prepared for a plurality of prediction directions of intra-picture prediction or a plurality of groups of prediction directions obtained by sorting a plurality of prediction directions, respectively, and a code table corresponding to information of a prediction direction or a group of prediction predictions used for the intra-picture prediction is selected from the plurality of code tables, and coefficient information is subjected to variable-length coding according to the selected code table.

Further, occurrence probabilities of coefficient information for a plurality of prediction directions of the intra-picture prediction or a plurality of groups of prediction directions obtained by sorting a plurality of prediction directions are estimated respectively, the occurrence probability of coefficient information is selected from the estimated occurrence probabilities using information of the prediction direction used for intra-picture prediction, and the coefficient information is subjected to variable-length decoding according to the selected occurrence probability.

Further, a plurality of code tables are prepared for a plurality of prediction directions of intra-picture prediction or a plurality of groups of prediction directions obtained by sorting a plurality of prediction directions, respectively, a code table corresponding to information of the prediction direction or the group of prediction directions used for intra-picture prediction is selected from a plurality of code tables, and the coefficient information is subjected to variable-length decoding according to the selected code table.

According to the present invention, selection of the probability estimator for coefficient information or a code table using information of the prediction direction of intra-picture prediction allows encoding to be performed according to coefficient information different due to the prediction directions, so that encoding efficiency is improved.

It is possible to make a computer execute the procedure described in the present embodiments. Alternatively, it is possible to distribute the procedure by storing it in a storing medium such as magnetic disks (flexible disk, hard disk, etc.), optical disks (CD-ROM, DVD, etc.), semiconductor memories as a program allowing a computer execute the procedure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image encoding apparatus for encoding coefficient information representing a coefficient obtained by orthogonal-transforming a prediction error between a to-be-encoded image and a prediction image and quantizing an orthogonal-transformed prediction error, comprising:
a plurality of probability estimators provided for a plurality of prediction directions of intra-picture prediction and configured to estimate occurrence probabilities of coefficient information, respectively;
a switch configured to select a probability estimator from the provability estimators according to information of a prediction direction used for the intra-picture prediction; and
a variable length encoder configured to encode the coefficient information according to occurrence probability of coefficient information provided from the probability estimator selected with the switch.

2. The image encoding apparatus according to claim 1 wherein; the plurality of probability estimators corresponds to the plurality of prediction directions, respectively.

3. The image encoding apparatus according to claim 1, wherein the plurality of probability estimators correspond to a plurality of groups of prediction directions obtained by sorting the plurality of prediction directions, respectively, and the switch selects, from the probability estimators, a probability estimator corresponding to a group of prediction directions obtained by sorting prediction directions used for the intra-picture prediction.

4. An image encoding apparatus for encoding coefficient information representing a coefficient obtained by orthogonal-transforming a prediction error between a to-be-encoded image and a prediction image and quantizing an orthogonal-transformed prediction error, comprising:
a plurality of code tables provided for a plurality of prediction directions of intra-picture prediction;
a switch configured to select, from the code tables, a code table according to information of a prediction direction used for intra-picture prediction; and
a variable length encoder configured to encode the coefficient information according to the code table selected with the switch.

5. The image encoding apparatus according to claim 4, wherein the plurality of code tables correspond to the plurality of prediction directions, respectively.

6. The image encoding apparatus according to claim 4, wherein the plurality of code tables correspond to a plurality of groups of prediction directions obtained by sorting the plurality of prediction directions, and the switch selects, from the code tables, a code table corresponding to a group of prediction directions used for intra-picture prediction.

7. An image decoding apparatus for deriving a decoded image from a prediction error obtained by decoding coefficient information from input encoded data, dequantizing decoded information, and inverse-transforming dequantized decoded information and a prediction image generated from an already decoded image, comprising:
a plurality of probability estimators provided for a plurality of prediction directions of intra-picture prediction and configured to estimate an occurrence probability of coefficient information;
a switch configured to select, from the probability estimators, a probability estimator using information of a prediction direction used for the intra-picture prediction; and
a variable length decoder configured to decode the coefficient information according to occurrence probability of coefficient information provided from the probability estimator selected with the switch.

8. The image decoding apparatus according to claim 7, wherein the plurality of code tables correspond to the plurality of prediction directions, respectively.

9. The image encoding apparatus according to claim 7, wherein the plurality of probability estimators correspond to a plurality of groups of prediction directions obtained by sorting the plurality of prediction directions, respectively, and the switch selects, from the probability estimators, a probability estimator corresponding to a group of prediction directions obtained by sorting prediction directions used for the intra-picture prediction.

10. An image decoding apparatus for deriving a decoded image from a prediction error obtained by decoding coefficient information from input encoded data, dequantizing decoded information and inverse-transforming dequantized decoded information and a prediction image generated from an already decoded image, comprising:
a plurality of code tables provided for a plurality of prediction directions of intra-picture prediction;
a switch configured to select, from the code tables, a code table according to information of a prediction direction used for intra-picture prediction; and
a variable length decoder configured to decode the coefficient information according to a code table selected with the switch.

11. The image decoding apparatus according to claim 10, wherein the plurality of code tables correspond to the plurality of prediction directions, respectively.

12. The image encoding apparatus according to claim 10, wherein the plurality of probability estimators correspond to a plurality of groups of prediction directions obtained by sorting the plurality of prediction directions, respectively, and the switch selects, from the probability estimators, a probability estimator corresponding to a group of prediction directions obtained by sorting prediction directions used for the intra-picture prediction.
